(19) United States
(12) Patent Application Publication
(10) Pub. No.: US 2020/0231104 A1
(43) Pub. Date: Jul. 23, 2020

(54) IN-VEHICLE DEVICE

(71) Applicant: HONDA MOTOR CO., LTD., Tokyo (JP)

(72) Inventor: Kenta TAKENAKA, Wako-shi (JP)

(21) Appl. No.: 16/736,011

(22) Filed: Jan. 7, 2020

(30) Foreign Application Priority Data
Jan. 21, 2019 (JP) 2019-007902

(51) Int. Cl. B60R 16/023; G06F 3/147; B60R 25/20; B60W 10/30; B60K 37/02

(52) U.S. Cl. CPC B60R 16/0235; G06F 3/147; B60W 2050/146; B60W 10/30; B60K 37/02; B60R 25/209

(57) ABSTRACT

There is provided with an in-vehicle device. A peripheral image display unit captures a periphery of a vehicle and display a captured image. A control unit controls the peripheral image display unit. The control unit starts display by the peripheral image display unit if a start instruction of the vehicle is detected, and restricts the display if the start instruction is made by remote control from an outside of the vehicle even if the start instruction is detected.

### CROSS-REFERENCE TO RELATED APPLICATION

This application claims priority to and the benefit of Japanese Patent Application No. 2019-007902 filed on Jan. 21, 2019, the entire disclosure of which is incorporated herein by reference.

### BACKGROUND OF THE INVENTION

### Field of the Invention

The present invention relates to an in-vehicle device.

### Description of the Related Art

There is known a CMS (Camera Monitoring System) including cameras for capturing images in the rear region from the left and right side regions of an automobile and monitors for displaying the captured images in place of the left and right side mirrors of the vehicle. In Japanese Patent Laid-Open No. 2018-046424, while an occupant is on board or when he/she gets off the vehicle, energy saving of the vehicle is implemented by reducing the power consumption of the CMS if visual recognition is less needed for the captured images on the monitors.

In order to adjust air-conditioning in the interior of the vehicle before an occupant gets on the vehicle, the user may start the vehicle by remote control. Energy saving of the vehicle is also desired event at the time of starting the vehicle by such remote control.

### SUMMARY OF THE INVENTION

An embodiment of the present invention provides an in-vehicle devise that implements energy saving at the time of starting a vehicle.

According to one embodiment of the present invention, an in-vehicle device comprising: a peripheral image display unit configured to capture a periphery of a vehicle and display a captured image; and a control unit configured to control the peripheral image display unit, wherein the control unit starts display by the peripheral image display unit if a start instruction of the vehicle is detected, and restricts the display if the start instruction is made by remote control from an outside of the vehicle even if the start instruction is detected.

### BRIEF DESCRIPTION OF THE DRAWINGS

FIGS. 1A and 1B are a plan view and a side view of a vehicle including an in-vehicle device according to an embodiment of the present invention;

FIG. 2 is a view showing the interior of the vehicle shown in FIGS. 1A and 1B;

FIG. 3 is a block diagram of the in-vehicle device according to an embodiment of the present invention;

FIG. 4 is a flowchart showing an example of processing executed by the in-vehicle device shown in FIG. 3;

FIG. 5 is a flowchart showing an example of processing executed by the in-vehicle device shown in FIG. 3;

FIG. 6 is a timing chart showing an example of the start of a vehicle including the in-vehicle device shown in FIG. 3 and the display state of a display device;

FIG. 7 is a timing chart showing an example of the start state of a vehicle and the display state of a display device of a comparative example; and

FIG. 8 is a timing chart showing an example of the start state of the vehicle including the in-vehicle device shown in FIG. 3 and the display state of the display device.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

<Arrangement of Vehicle>

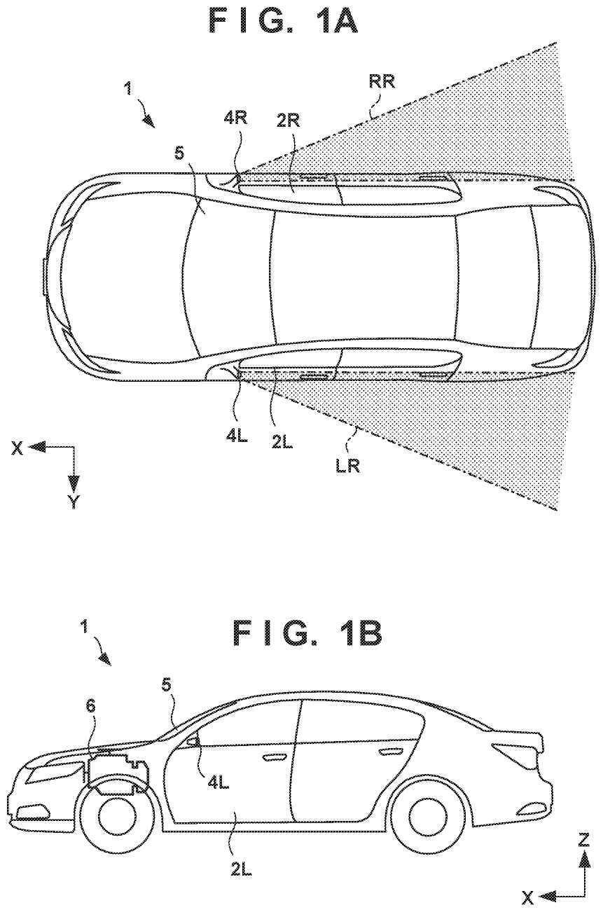

FIGS. 1A and 1B are a plan view and a side view of a vehicle 1 as an application example of the present invention. Note that in the drawings, an arrow X indicates the longitudinal direction of the vehicle 1, and an arrow Y indicates the vehicle width direction of the vehicle 1. An arrow Z indicates the vertical direction.

The vehicle 1 is, for example, a sedan-type four-wheeled vehicle. The vehicle 1 includes two seats in the front row adjacent to a windshield 5, and two seats in the rear row. The right seat in the front row is the driver's seat, and the left seat is the passenger seat. The vehicle 1 includes a total of four doors adjacent to the seats. A door 2R is the door adjacent to the driver's seat, and is the right door on the front side. A door 2L is the door adjacent to the passenger seat, and is the left door on the front side. A driving unit 6 is provided in the front part of the vehicle 1. The driving unit 6 includes a driving source that generates the driving force of the vehicle 1. In this embodiment, the driving source is an engine (internal combustion engine). The driving unit 6 includes an automatic transmission in addition to the engine.

The vehicle 1 includes image capturing devices 4R and 4L capable of capturing the periphery of the vehicle 1. Each of the image capturing devices 4R and 4L is, for example, a camera including an image capturing element such as an image sensor and an optical system such as a lens. The image capturing device 4R is arranged in front of the door 2R, and has an image capturing range RR in the rear on the right side of the vehicle 1. The image capturing device 4L is arranged in front of the door 2L, and has an image capturing range LR in the rear on the left side of the vehicle 1. The image capturing devices 4R and 4L are generically called image capturing devices 4.

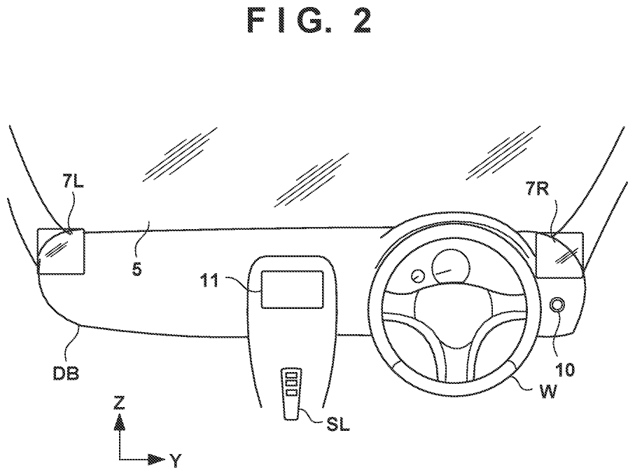

FIG. 2 is a view schematically showing the interior of the vehicle 1, and is a view particularly showing the periphery of a dashboard DB. A steering wheel W is provided in front of the driver's seat. A start switch 10 is provided at the right end of the dashboard DB. The driver can instruct the engine start of the driving unit 6 by operating the start switch 10. A display device 11 configured to display map information or the like is provided at the center of the dashboard DB in the vehicle width direction, and a shift lever SL that accepts a shift operation for the automatic transmission is arranged near the display device 11.

A display device 7R is arranged at the right end of the dashboard DB, and a display device 7L is arranged at the left end. Each of the display devices 7R and 7L is an image display device, and is, for example, a liquid crystal display device. An image captured by the image capturing device 4R is displayed on the display device 7R, and an image captured by the image capturing device 4L is displayed on the display device 7L. The display devices 7R and 7L are generically called display devices 7. In addition, in this embodiment, the image capturing devices 4 and the display devices 7 form a peripheral image display device 3 that captures the periphery of the vehicle 1 and display the captured images.

The vehicle 1 according to this embodiment is a side-mirrorless vehicle. The peripheral image display device 3 (the image capturing devices 4 and the display devices 7) forms a camera monitoring system (CMS) provided to cause the occupant (in particular, the driver) to confirm the sides and the rear of the vehicle 1 in place of side mirrors (door mirrors). Hence, at least during traveling of the vehicle 1, the display devices 7 always display images captured by the image capturing devices 4.

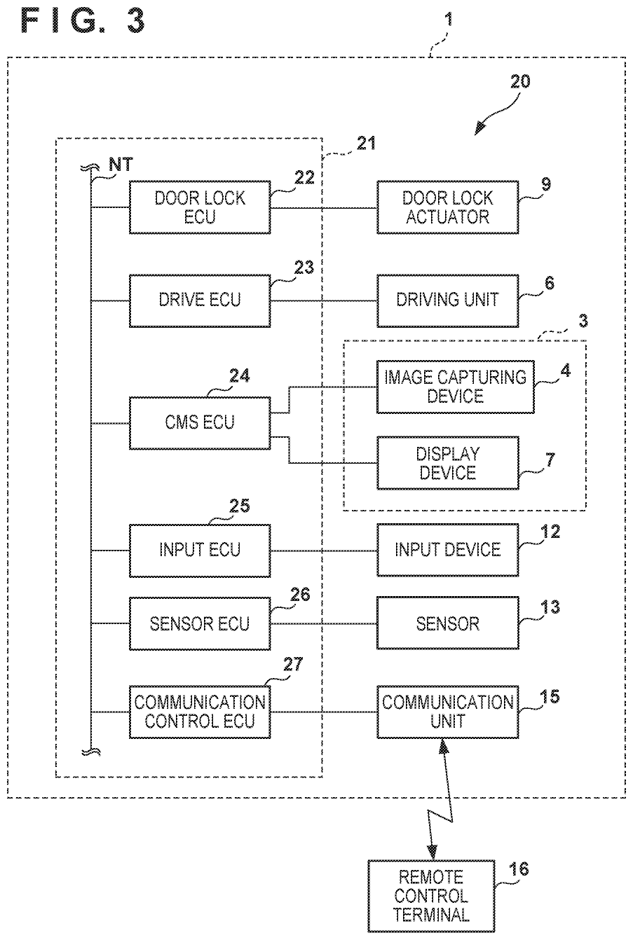

FIG. 3 is a block diagram showing an example of the arrangement of an in-vehicle device 20 of the vehicle 1. The in-vehicle device 20 is a unit configured to control each device in the vehicle 1. FIG. 3 shows only components needed in association with the feature of this embodiment to be described later.

The in-vehicle device 20 includes a control unit 21. The control unit 21 includes a plurality of ECUs (Electric Control Units) 22 to 27. The ECUs are connected to be communicable with each other via an in-vehicle network NT. Each ECU includes a processor represented by a CPU, a storage device such as a semiconductor memory, an interface to an external device, and the like. The storage device stores a program to be executed by the processor, data to be used by the processor for processing, and the like. Each ECU may include a plurality of processors, storage devices, and interfaces. Note that the number of ECUs and the provided functions can appropriately be designed, and they can be subdivided or integrated as compared to this embodiment.

The ECU 22 controls locking/unlocking of a door by a door lock actuator 9. The ECU 23 controls the driving unit 6. The ECU 24 controls the peripheral image display device 3 including the image capturing devices 4 and the display devices 7 to constitute a camera monitoring system. The ECU 25 accepts the operation of an occupant to an input device 12. The input device 12 includes the start switch 10 described above and a remote control unit or a door switch for performing locking/unlocking of the door. The ECU 26 controls a sensor 13 to acquire the detection result. The sensor 13 includes a door opening/closing sensor for detecting the opening/closing of the door in relation to the following description. The ECU 27 controls a communication unit 15 for performing external communication with the vehicle 1. In the relation to the following description, the communication unit 15 communicates with a remote control terminal 16 (to be described later) and accepts the operation of the control terminal 16. Note that in FIG. 3, representative function names are assigned to the ECUs 22 to 27. For example, the ECU 22 is described as the “door lock ECU”.

The remote control terminal 16 is a terminal capable of outputting an operation instruction for the vehicle 1 by remote control from the outside of the vehicle 1. In this embodiment, the remote control terminal 16 can output the start instruction for the driving source of the driving unit 6. When the start instruction is output from the remote control terminal 16, the communication unit 15 accepts the instruction and the ECU27 notifies the ECU 23 of the start instruction. The remote control terminal 16 can be a dedicated remote control unit for operating the vehicle 1 or a user terminal such as a smartphone in which an application capable of performing the operation of the vehicle 1 is installed. The occupant starts the vehicle 1 by remote control before he/she gets on the vehicle 1, thereby performing the warm-up operation of the driving unit 6, air-conditioning operation of the interior, and the like. In the following description, in this embodiment, the start and the start instruction of the vehicle 1 indicate the start and the start instruction of the engine of the driving unit 6. However, as will be described in the <Other Embodiments>, processing to be described later is not limited to the start time of the engine.

<Processing Example of Control Unit>

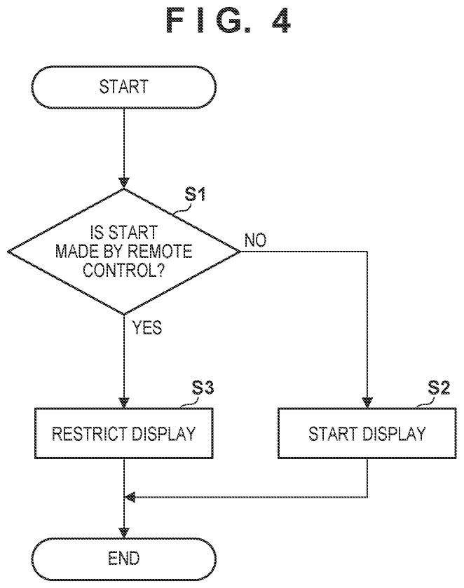

The processing example of the control unit 21 will be described below. FIG. 4 is a flowchart showing an example of image display processing of the peripheral image display device 3 which is executed by the CPU 24. The ECU 24 starts the display of captured images of the image capturing devices 4 on the display devices 7 when the start instruction of the vehicle 1 is output. However, if the start instruction of the vehicle 1 is performed by remote control, the captured images are displayed on the display devices 7 although the occupant is not onboard. This operation is unnecessary display of the captured images, and unnecessary power consumption occurs. To cope with this, in this embodiment, even if the start instruction of the vehicle 1 is made, and this instruction is made by remote control, the display of the captured images is restricted. By this restriction, the unnecessary display of the captured images can be suppressed, the power consumption can be reduced, and the power saving of the vehicle 1 can be achieved.

The processing in FIG. 4 is started upon a notification that the vehicle 1 has started from the ECU 23 to the ECU 24. In this state, the display devices 7 are set in a non-display state in which the captured images of the image capturing devices 4 are not displayed. In step S1, the ECU 24 determines whether the start instruction is made by remote control. For example, the ECU 24 communicates with the ECUs 23 and 27 to determine whether the start instruction is made by remote control. If the start instruction is not made by remote control, that is, if the start instruction is input in the interior of the vehicle such that the start switch 10 is pressed, the ECU 24 advances the process to step S2. The display of the captured images on the display devices 7 is started, and the processing ends. On the other hand, if the start instruction is made by remote control, the ECU 24 advances the process to step S3. Processing ends without starting the display of the captured image on the display device 7. That is, if the start instruction is made by remote control, the processing ends while display of the display devices 7 is restricted even if the vehicle 1 starts.

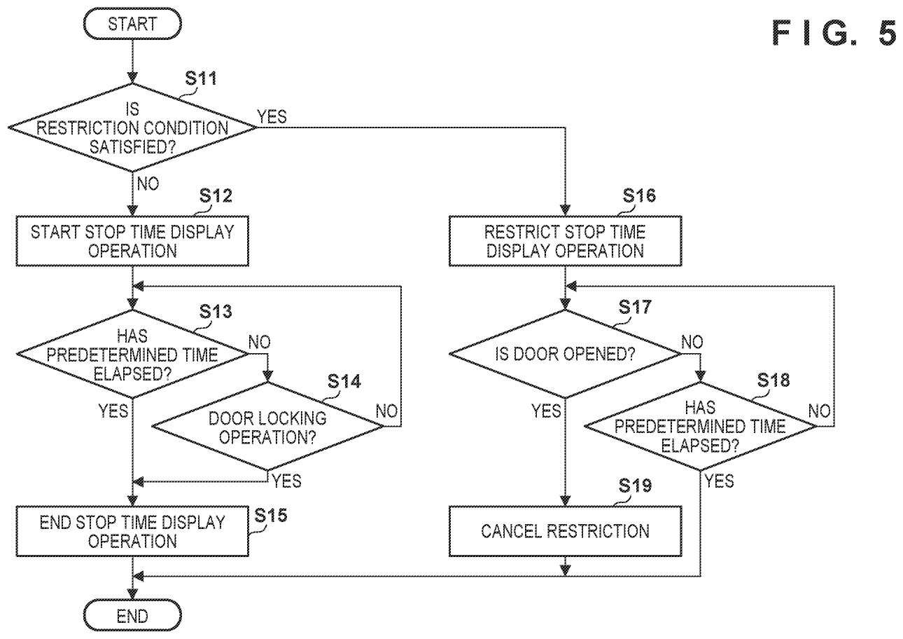

With the above arrangement, only when the start instruction of the vehicle 1 is made by an operation inside the interior of the vehicle 1, the display devices 7 display the captured images. If the start instruction is made by remote control, the display is restricted. Therefore, unnecessary display of the captured images at the time of the start of the vehicle 1 can be suppressed, and the power consumption can be reduced. Note that in this embodiment, if the processing in FIG. 4 ends without starting the display of the captured images on the display devices 7, the display of the captured images is started until the start of traveling based on processing (to be described below) in FIG. 5.

FIG. 5 is a flowchart showing an example of processing of the ECU 24 when the vehicle 1 stops from the started state. Even if the occupant ends the use of the vehicle 1 and stops the vehicle 1 from the started state, it is desirable that the display of the display devices 7 is continued until the occupant gets off the vehicle in order to ensure the visibility of the periphery when the occupant gets off the vehicle. For this reason, in some cases, the ECU 24 performs a stop time display operation for performing the display of the captured images on the display devices 7 until a predetermined requirement is satisfied even if the vehicle 1 stops from the started state. In this embodiment, the stop time display operation is executed until a predetermined time has elapsed after the vehicle 1 stops from the started state, or until the occupant gets off the vehicle and locks the doors from the outside of the vehicle 1.

On the other hand, in a vehicle capable of inputting a start instruction by remote control, for the antitheft viewpoint or the like, if an operation of opening/closing the door is made from the outside of the vehicle 1 in a case in which the start of the vehicle 1 is made by remote control, the start of the vehicle 1 is temporarily stopped in some cases. In this embodiment, if the door unlocking operation is made from the outside the vehicle in a case in which the vehicle 1 is started by the remote control, the start of the vehicle 1 is stopped.

However, for example, in a vehicle which executes the above stop time display operation, if the door unlocking operation is made during the start of the vehicle by remote control, and the start of the vehicle is stopped, unnecessary display of the captured images is made while the occupant is located outside the vehicle, thus unnecessarily consuming the power of the vehicle.

To cope with this, in this embodiment, if the start of the vehicle before the stop made from the started state of the vehicle 1 is made by remote control, the stop time display operation is restricted. Accordingly, the display of the captured images on the display devices 7 is continued even if the start of the vehicle 1 is stopped when the occupant gets off the vehicle, and the display of the captured images on the display devices 7 can be suppressed at the time of the stop of the start based on the operation after the start by the remote control.

The processing in FIG. 5 is started when the vehicle 1 in the started state is stopped and the stop of the vehicle 1 is notified from the ECU 23 to the ECU 24. In step S11, the ECU 24 determines whether the stop of the vehicle 1 from the started state satisfies a restriction condition of the stop time display operation. In this embodiment, if the vehicle 1 is started based on the start instruction by remote control and the vehicle stops in response to unlocking of the doors from the outside of the vehicle, the ECU 24 determines to satisfy the restriction condition. The ECU 24 performs the determination based on, for example, the notifications from the ECUs 22 and 23. If the restriction condition is satisfied, the ECU 24 advances the process to step S16; otherwise, the process advances to step S12.

In step S12, the ECU 24 starts the stop time display operation. This operation is assumed to be executed, for example, when the occupant stops to use the vehicle 1 and the start of the vehicle 1 is stopped in the interior of the vehicle 1. This operation makes it possible to ensure the visibility of the periphery when the occupant gets off the vehicle. By this operation, if the display devices 7 are set in the display state when the vehicle 1 is stopped, the display is continued. If the display devices 7 are in a non-display state, the display is started.

In step S13, the ECU 24 determines whether a predetermined time has elapsed from the stop. If the predetermined time has elapsed, the process advances to step S15 to end the stop time display operation, thereby ending the processing in FIG. 5. That is, the display of the captured images on the display devices 7 ends. However, if the predetermined time has not elapsed, the process advances to step S14. In step S14, the ECU 24 determines whether a door locking operation was performed. For example, the ECU 24 determines based on the notification from the ECU 22 whether a door locking operation was performed. If a door locking operation was performed, the process advances to step S15, and the stop time display operation is ended, thereby ending the processing in FIG. 5. If a door locking operation was not performed, the process returns to step S13. If a door locking operation was performed during execution of the stop time display operation, it can be estimated that the occupant has already gotten off the vehicle. Therefore, by ending the stop time display operation based on the door locking operation, the unnecessary display on the display devices 7 in a state in which the occupant has already gotten off the vehicle can be suppressed.

On the other hand, when the process advances from step S11 to step S16, the ECU 24 restricts the stop time display operation. Accordingly, the display devices 7 are changed from the display state to the non-display state or continue the non-display sate from the start. If the restriction condition is established, it is estimated that the occupant is present outside the vehicle. For this reason, the captured images are not displayed on the display devices 7, thereby suppressing the unnecessary display. After that, in step S17, the ECU 24 determines whether a door is opened. For example, the ECU 24 performs the determination based on whether a signal from the door opening/closing sensor is received by a notification from the ECU 26. If the opening operation of the door is detected, the process advances to step S19 to cancel the restriction of the stop time display operation, thereby ending the processing. By canceling the restriction, the display of the display devices 7 is started. By starting the display of the captured images by the door opening operation, a delay in the display of the captured images at the time of the start of the vehicle 1 after the occupant gets on the vehicle can be suppressed.

If the ECU 24 determines in step S17 that the opening operation is not performed, the ECU 24 advances the process to step S18 to determine whether a predetermined time has elapsed. If the predetermined time has not elapsed, the process returns to step S17. However, if the predetermined time has elapsed, the processing in FIG. 5 ends. Note that the determination in step S18 to determine whether the predetermined time has elapsed can be omitted. In this case, if the restriction condition is established in step 511, the display of the display devices 7 can be started in response to the door opening operation regardless of the time elapsed after the vehicle 1 is stopped.

Note that the restriction condition in this embodiment is defined such that “the vehicle 1 is started based on the start instruction by remote control and stopped in response to the door unlocking from the outside of the vehicle 1”. However, the restriction condition is merely an example. For example, the stop of the vehicle after the start by remote control may be defined as the restriction condition. The vehicle 1 may include an arrangement in which its start is stopped when the occupant is not directed to the vehicle 1 (the occupant does not get on the vehicle) after the start by the remote control, and a predetermined time has elapsed when the occupant does not perform any operation such as door unlocking or a door opening operation. Even in this case, by using the stop of the vehicle after the start by remote control is defined as the restriction condition, the power consumption can be reduced without performing display (the stop time display operation in step S12) of the display devices 7 in synchronism with the stop of the start. In the vehicle 1 which changes from the start state to the stop state by, for example, the door opening operation by the start of the vehicle 1 by remote control, the start by remote control and the stop from the start state in response to the door opening operation may be defined as the restriction condition. Note that an arrangement in which if any one of a plurality of restriction conditions is satisfied, the stop time display operation is restricted can also be employed.

In addition, according to this embodiment, the restriction of the stop time display operation is canceled by the door opening operation. However, an arrangement for canceling the restriction can be arbitrarily changed. For example, a seating sensor capable of detecting the seating of an occupant may be arranged under the driver's seat, and the restriction may be canceled when the seating of the occupant is detected. Alternatively, processing from steps S17 for canceling the restriction may not be performed, and the display of the captured images on the display devices 7 may be started when an instruction to start vehicle is made in the interior of the vehicle. Note that the predetermined time in step S13 and the predetermined time in step S18 may be equal to or different from each other.

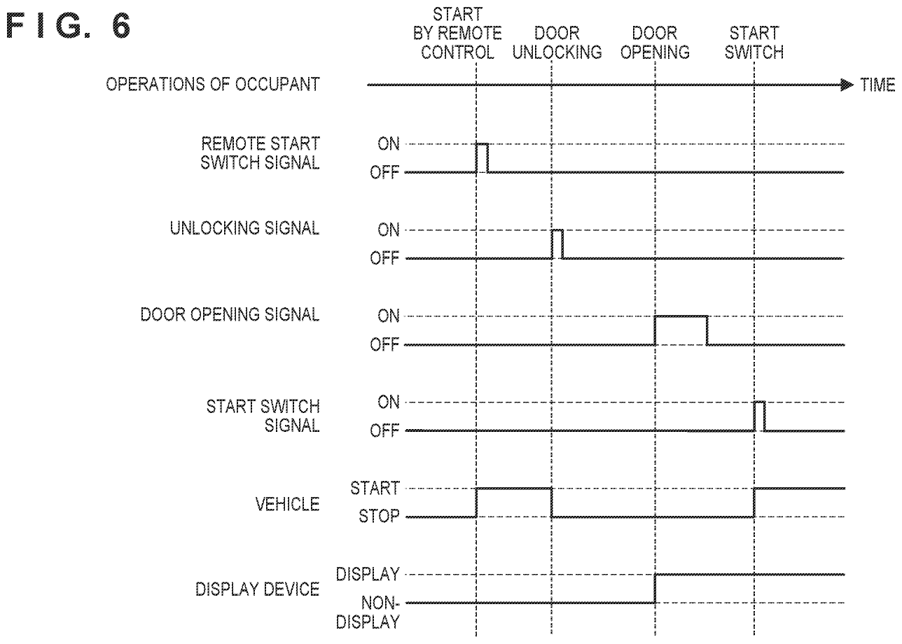

FIG. 6 is a timing chart schematically showing the start state of the vehicle 1 and the display state of the captured images on the display devices 7 based on the processing to be executed in the in-vehicle device 20 according to this embodiment. The operations of the occupant in FIG. 6 indicate the operations from the vehicle being started by remote control to the vehicle being restarted after the occupant gets on the vehicle. Note that FIG. 6 is a schematic view and omits time differences due to the start and response delays of the respective elements and the like.

If the occupant operates the remote control terminal 16 to input a start instruction of the vehicle 1, this signal (a remote start switch signal) is input to the communication unit 15. Upon detection of the remote start switch signal, the ECU 27 notifies other ECUs of the start instruction. The ECU 23 starts the engine of the driving unit 6 based on the notification. On the other hand, since the start is made using the start instruction by remote control, the ECU 24 does not display the captured images of the image capturing devices 4 on the display devices 7 (steps S1 and S3 in FIG. 4).

After that, when the occupant performs the door unlocking to get on the vehicle, the ECU 22 detects a door unlocking signal. The ECU 22 notifies other ECUs of the door unlocking. The ECU 24 stops the vehicle 1 from the started state in response to the door unlocking after the start by remote control. The ECU 24 determines based on this stop that the restriction condition (step S11 in FIG. 5) is established, the non-display state of the display devices 7 is continued because the ECU 24 restricts the stop time display operation (step S16 in FIG. 5).

Subsequently, when the occupant performs a door opening operation to get in the vehicle, the ECU 26 detects the signal of the door opening/closing sensor. The ECU 26 notifies other ECUs of the door opening operation. The ECU 24 cancels the restriction of the stop time display operation based on the door opening operation (steps S17 and S19 in FIG. 5), thereby starting the display of the captured images on the display devices 7. The start of the display devices 7 may take time after the instruction by the ECU 24 is made. However, by inputting the instruction from the ECU 24 to the display devices 7 in response to the door opening operation, the display of the captured images on the display devices 7 can be started before the occupant starts performing the driving operation even if it takes time to start the display devices 7.

In addition, when the occupant presses the start switch 10 in the interior of the vehicle after the occupant gets in the vehicle, the ECU 25 detects the start switch signal. When the ECU 25 notifies other ECUs of the detection of the start switch signal, the ECU 24 starts the engine of the driving unit 6, and the vehicle 1 is set in the start state.

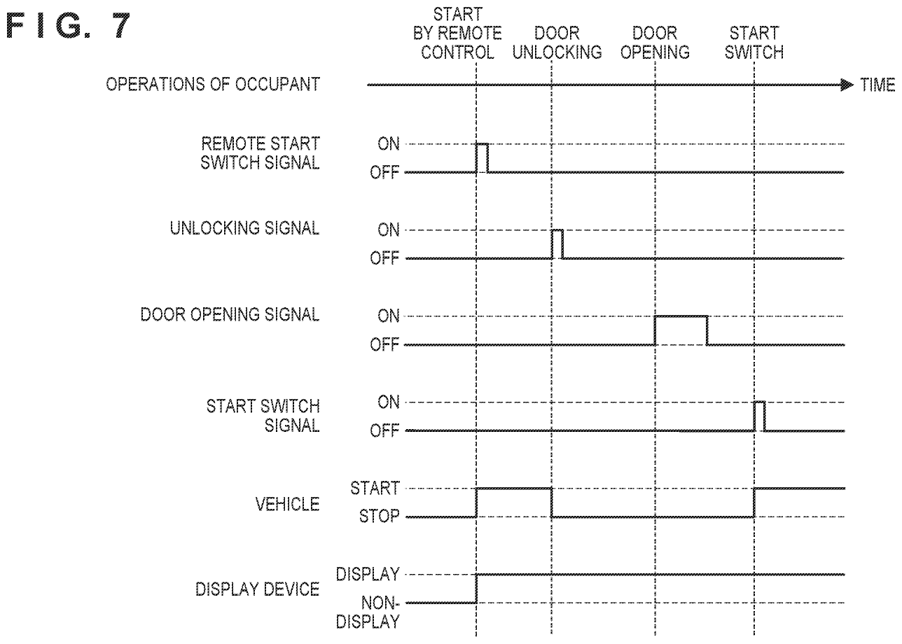

FIG. 7 is a timing chart schematically showing the start state of the vehicle which does not performed processing according to this embodiment and the display state of the captured images on the display devices as a comparative example. In the case shown in FIG. 7, the display devices display the captured images when the vehicle is set in the start state based on the remote start switch signal. Accordingly, as compared with the case in which the processing according to this embodiment is performed, unnecessary display of the captured images on the display devices is performed while the vehicle is started by remote control and the door opening operation is performed. By executing the processing according to this embodiment, unnecessary display of the captured images on the display devices 7 before the occupant gets on the vehicle 1 can be suppressed.

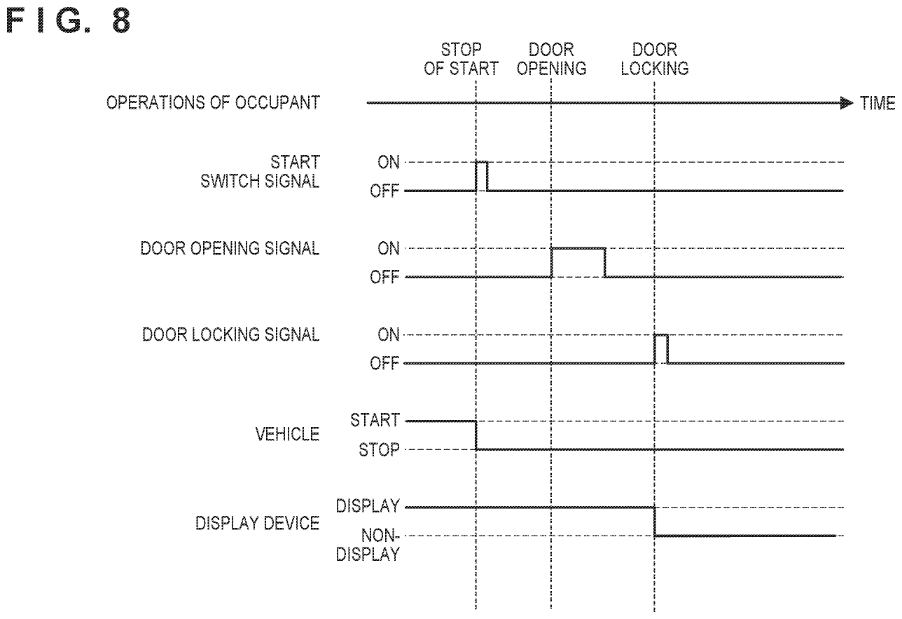

FIG. 8 is a timing chart schematically showing the start state of the vehicle 1 when an occupant gets off the vehicle 1 including the in-vehicle device 20 according to this embodiment and the display state of the display devices 7. Since the initial state is a state in which the occupant uses the vehicle 1, the vehicle 1 is set in the start state, and the display devices 7 are set in the display state.

When the occupant ends the use of the vehicle 1 and presses the start switch 10, the vehicle 1 is stopped from the started state based on the start switch signal. The ECU 24 determines whether the restriction condition (step S11 in FIG. 5) is established. In the example of FIG. 8, since the stop is not a stop in response to door unlocking, the restriction condition is not satisfied. Accordingly, the ECU 24 starts the stop time display operation of the display devices 7 (step S12 in FIG. 5). In the example of FIG. 8, since the display devices 7 are set in the display state in the initial state, the display of the captured images is continued.

After that, when the occupant performs the door opening operation to get off the vehicle and then performs the door locking operation, the ECU 24 ends the stop time display operation of the display devices 7 (steps S14 and S15 in FIG. 5). Note that if a predetermined time has elapsed from the stop without performing the door locking operation, the stop time display operation ends (step S13 in FIG. 5).

As described above, the display of the display devices 7 is continued even after the vehicle 1 is stopped from being started when the occupant gets off the vehicle 1, while suppressing the unnecessary display of the display devices 7 when the occupant gets on the vehicle. Therefore, both the reduction of the power consumption by the display devices 7 when the occupant gets on the vehicle and the visibility of the periphery when the occupant gets off the vehicle can be ensured.

### Other Embodiments

In the above embodiment, the above processing is performed by determining the start instruction and the start state of the vehicle 1 based on the start instruction and the start state of the engine of the driving unit 6. However, the start instruction and the start state of the vehicle 1 may be determined based on the ON/OFF of an accessory power supply or an ignition power supply of the vehicle 1. That is, a state in which a predetermined system of the vehicle 1 is set in an operable state can be defined as the start state. In this case, unnecessary display of the captured images in a case in which the predetermined system of the vehicle 1 is set in the operable state can be suppressed, thereby reducing the power consumption.

In addition, if an accessory power supply ON state is defined as the start state, all the states (for example, the ignition power supply ON state and the engine start state) in which the number of operable functions is larger than the accessory power supply ON state may be defined as the start states. All the start states such as the accessory power supply ON state, the ignition power supply ON (and engine stop) state, and the engine start state are defined as the start states, and the remaining states (for example, a state in which only the power supply voltage is always applied) may be defined as the stop states.

In addition, the display restriction mode of the captured images of the display devices 7 can be appropriately designed. For example, in a state in which the image capturing devices 4 and the display devices 7 are activated, the display devices 7 may be set in the non-display state or dimmed state. In this case, since the image capturing devices 4 and the display devices 7 have been activated, the display can be immediately started when the display restriction is canceled. In addition, for example, in a state in which the image capturing devices 4 are activated, the activation of the display devices 7 may be stopped, or the activation of the image capturing devices 4 and the display devices 7 may be stopped. In this case, the power consumption can be lower than a case in which the display is set in the non-display state while the display devices 7 are activated.

In the above-described embodiment, as the driving source provided in the driving unit 6, an internal combustion engine has been exemplified. However, another driving source such as an electric motor may be employed. Alternatively, the driving source may be formed by a combination of a plurality of devices like a combination of an internal combustion engine and an electric motor. If the driving source includes an electric motor, an alarm condition representing that the electric motor is in an operable state can be, for example, a state in which the driving circuit of the electric motor is activated. In the above embodiment, a four-wheeled vehicle is exemplified as a vehicle including the in-vehicle device. However, the present invention is also applicable to a two-wheeled vehicle or any other vehicle.

### Summary of Embodiment

The above-described embodiment discloses at least the following in-vehicle device.

1. According to the above embodiment, there is provided an in-vehicle device (for example, 20) comprising:

peripheral image display unit (for example, 3) configured to capture a periphery of a vehicle (for example, 1) and displaying a captured image; and control unit (for example, 24) configured to control the peripheral image display unit,

wherein the control unit starts display by the peripheral image display unit if a start instruction of the vehicle is detected, and

restricts the display if the start instruction is made by remote control from an outside of the vehicle even if the start instruction is detected (for example, FIG. 5).

According to this embodiment, since the peripheral image display unit does not display the captured image when the vehicle is started by remote control in a state in which any occupant is not present in the interior of the vehicle, unnecessary display of the captured image can be suppressed. Therefore, energy saving of the vehicle can be achieved.

2. In the above embodiment,

the start instruction is an instruction for starting a driving source (for example, 6) of the vehicle.

According to this embodiment, the unnecessary display of the captured image on the peripheral image display unit at the time of starting the driving source by remote control can be suppressed.

3. In the above embodiment,

the start instruction is an instruction to turn on an accessory power supply of the vehicle.

According to this embodiment, the unnecessary display of the captured image on the peripheral image display unit at the time of starting a vehicle system by remote control can be suppressed.

4. In the above embodiment,

the peripheral image display unit can capture images in the sides and rear of the vehicle while the vehicle is being started.

According to this embodiment, unnecessary display for displaying external information of the vehicle in the started state of the vehicle can be suppressed.

5. In the above embodiment,

the control unit executes a stop time display operation for displaying the captured image on the peripheral image display unit if the vehicle is changed from a started state to a stop state of the start, and

restricts the stop time display operation if the vehicle is started using the start instruction by remote control and the start is stopped even if the vehicle is changed from the started state to the stop state.

According to this embodiment, the display of the captured image is continued even after the stop of the vehicle when the occupant gets off the vehicle while unnecessary display of the captured image is suppressed when the occupant gets on the vehicle using the start instruction by remote control. Therefore, both the reduction of the power consumption by the peripheral image display unit when the occupant gets on the vehicle and the visibility of the periphery when the occupant gets off the vehicle can be ensured.

6. In the above embodiment,

the control unit restricts the stop time display operation when the vehicle starts by the start instruction by the remote control and the start is stopped upon an elapse of a predetermined time from the start, even if the vehicle is changed from a started state to a stop state.

According to this embodiment, in a vehicle that is stopped from starting upon the elapse of the predetermined time after the start by remote control, unnecessary display of the captured image can be suppressed, and the power consumption of the peripheral image display unit can be reduced.

7. In the above embodiment,

the control unit restricts the stop time display operation when the vehicle starts by the start instruction by the remote control and the start is stopped by an operation concerning door opening/closing from an outside of the vehicle, even if the vehicle is changed from a started state to a stop state.

According to this embodiment, in a vehicle that is stopped from starting by the operation concerning the door opening/closing from the outside of the vehicle after the start by the remote control, the unnecessary display of the captured image can be suppressed, and the power consumption of the peripheral image display unit can be reduced.

8. In the above embodiment,

the operation concerning the door opening/closing is a door unlocking operation.

According to this embodiment, when the vehicle is stopped from being started based on door unlocking, the unnecessary display of the captured image by the peripheral image display unit can be restricted.

9. In the above embodiment,

the operation concerning the door opening/closing is a door opening operation of the vehicle.

According to this embodiment, when the vehicle is stopped from being started based on the door opening operation, the unnecessary display of the captured image by the peripheral image display unit can be restricted.

10. In the above embodiment, the control unit cancels restriction of the stop time display operation if a door opening operation of the vehicle is performed in a case in which the stop time display operation is restricted.

According to this embodiment, occurrence of a display delay of the captured image when the vehicle is started after the occupant gets on the vehicle is suppressed by canceling the restriction of the stop time display operation by the door opening operation, while the unnecessary operation of the stop time display operation when the occupant gets on the vehicle is suppressed.

The invention is not limited to the foregoing embodiments, and various variations/changes are possible within the spirit of the invention.

What is claimed is:

1. An in-vehicle device comprising:
a peripheral image display unit configured to capture a periphery of a vehicle and display a captured image; and
a control unit configured to control the peripheral image display unit,
wherein the control unit starts display by the peripheral image display unit if a start instruction of the vehicle is detected, and
restricts the display if the start instruction is made by remote control from an outside of the vehicle even if the start instruction is detected.

2. The device according to claim 1, wherein the start instruction is an instruction for starting a driving source of the vehicle.

3. The device according to claim 1, wherein the start instruction is an instruction to turn on an accessory power supply of the vehicle.

4. The device according to claim 1, wherein the peripheral image display unit can capture images in the sides and rear of the vehicle while the vehicle is being started.

5. The device according to claim 1, wherein the control unit executes a stop time display operation for displaying the captured image on the peripheral image display unit if the vehicle is changed from a started state to a stop state of the start, and
restricts the stop time display operation if the vehicle is started using the start instruction by remote control and the start is stopped even if the vehicle is changed from the started state to the stop state.

6. The device according to claim 5, wherein the control unit restricts the stop time display operation when the vehicle starts by the start instruction by the remote control and the start is stopped upon an elapse of a predetermined time from the start, even if the vehicle is changed from a started state to a stop state.

7. The device according to claim 5, wherein the control unit restricts the stop time display operation when the vehicle starts by the start instruction by the remote control and the start is stopped by an operation concerning door opening/closing from an outside of the vehicle, even if the vehicle is changed from a started state to a stop state.

8. The device according to claim 7, wherein the operation concerning the door opening/closing is a door unlocking operation.

9. The device according to claim 7, wherein the operation concerning the door opening/closing is a door opening operation of the vehicle.

10. The device according to claim 5, wherein the control unit cancels restriction of the stop time display operation if a door opening operation of the vehicle is performed in a case in which the stop time display operation is restricted.
